(19) United States
(12) Patent Application Publication
(10) Pub. No.: US 2025/0366396 A1
(43) Pub. Date: Dec. 4, 2025

(54) Attachment for an Agricultural Harvesting Machine and Agricultural Harvesting Machine

(71) Applicant: CLAAS Saulgau GmbH, 88348 Bad Saulgau (DE)

(72) Inventors: Christian König, Oberteuringen (DE); Christoph Kaufmann, Hohentengen (DE); Florian Wälder, Sigmaringendorf (DE); Sebastian Blender, Herdwangen-Schönach (DE)

(21) Appl. No.: 19/219,928

(22) Filed: May 27, 2025

(30) Foreign Application Priority Data
May 28, 2024 (DE) 102024114967.1

(51) Int. Cl. A01D 61/00; A01D 69/03

(52) U.S. Cl. CPC A01D 61/008; A01D 69/03

(57) ABSTRACT

Attachment (10) for an agricultural harvesting machine having a main frame (11) which is configured to couple the attachment (10) to the agricultural harvesting machine, and having a harvested material conveying device (12) which is secured to the main frame (11) by means of carriers (15) in such a manner that the harvested material conveying device (12) is rotatably supported on the carriers (15) and can be pivoted together with the carriers (15) with respect to the main frame (11), wherein the harvested material conveying device (12) is configured to convey in cooperation with a base metal sheet (14) the harvested material. At least one 10 hydraulic cylinder (18) engages directly or indirectly on the main frame (11) and on at least one carrier (15) or an auxiliary frame (19) which is connected to the carriers (15), wherein the at least one hydraulic cylinder (18) is configured, on the one hand, to press or pull the harvested material conveying device (12) with a defined pretensioning in the direction towards the base metal sheet (14).

The invention relates to an attachment for an agricultural harvesting machine and an agricultural harvesting machine having an attachment.

DE 10 2012 011 574 B4 discloses an attachment which is in the form of a receiving apparatus for an agricultural harvesting machine. The receiving apparatus has a main frame which is configured to couple the receiving apparatus to the agricultural harvesting machine. Furthermore, the receiving apparatus has a harvested material receiving device and a harvested material conveying device. The harvested material receiving device is secured to the main frame and is configured for receiving harvested material from underlying ground. The harvested material conveying device is pivotably secured to the main frame by means of carriers, wherein the harvested material conveying device is configured in cooperation with a base metal sheet to convey the harvested material received by the harvested material receiving device.

DE 198 47 891 A1 discloses another attachment which is in the form of a receiving apparatus for an agricultural harvesting machine having a harvested material receiving device and a harvested material conveying device.

It is known from practice to lift out or raise the harvested material conveying device of such a receiving apparatus via at least one single-acting hydraulic cylinder counter to the resilient force of at least one resilient element, that is to say to move it away from the base metal sheet. The at least one resilient element pulls or presses the harvested material conveying device with a pretensioning being provided between the harvested material conveying device and base metal sheet in the direction towards the base metal sheet. The resilient force of the at least one resilient element counteracts the raising or lifting-out of the harvested material conveying device, whereby the permissible resilient force of the resilient element and consequently pretensioning between the harvested material conveying device and base metal sheet is limited.

There is a need for the pretensioning of the harvested material conveying device to be increased in the direction towards the base metal sheet in order to improve the transport of the harvested material.

Based on this, an object of the present invention is to provide a novel attachment for an agricultural harvesting machine and an agricultural harvesting machine having such an attachment.

This object is achieved with an attachment according to claim 1 and an agricultural harvesting machine according to claim 10.

According to the invention, at least one hydraulic cylinder engages directly or indirectly on the main frame and on at least one carrier or an auxiliary frame which is connected to the carriers, wherein the at least one hydraulic cylinder is configured, on the one hand, to press or pull the harvested material conveying device with a defined pretensioning being provided in the direction towards the base metal sheet and, on the other hand, to move the harvested material conveying device away from the base metal sheet.

The attachment according to the invention uses at least one hydraulic cylinder in order to provide the defined pretensioning between the harvested material conveying device and base metal sheet and for raising or lifting out the harvested material conveying device from the base metal sheet. With little structural space required compared with the solution known from the prior art, which uses resilient elements, the pretensioning between the harvested material conveying device and base metal sheet can thereby be increased in order to thus transport the harvested material in an optimum manner in the region of the harvested material conveying device.

Preferably, at both sides of the harvested material conveying device a hydraulic cylinder engages on the main frame and on the respective carrier or on the auxiliary frame in each case. This embodiment is particularly preferred in order over the longitudinal extent of the harvested material conveying device to provide the most uniform, defined possible pretensioning thereof in the direction towards the base metal sheet.

Preferably, the respective hydraulic cylinder is in the form of a dual-action hydraulic cylinder and has a cylinder and a piston which can be displaced in the cylinder, wherein at both sides of the piston in each case a hydraulic chamber is formed. When a first hydraulic chamber is filled with hydraulic oil, the harvested material conveying device is pressed or pulled with pretensioning being provided between the harvested material conveying device and base metal sheet in the direction towards the base metal sheet. When a second hydraulic chamber is filled with hydraulic oil, the harvested material conveying device is moved away from the base metal sheet. This embodiment is structurally particularly simple and requires little structural space.

Preferably, the first hydraulic chamber is coupled by means of a first hydraulic line to a hydraulic store and a hydraulic pump, wherein, in the first hydraulic line, there is arranged a switchable valve which in a first position connects the hydraulic pump to the first hydraulic chamber and which in a second position separates the hydraulic pump from the first hydraulic chamber. The hydraulic store is in both positions of the valve connected to the first hydraulic chamber, wherein the hydraulic store is connected to the hydraulic pump exclusively in the first position of the valve. This embodiment is also structurally particularly simple and requires little structural space.

Preferably, the attachment is in the form of a receiving apparatus which further has a harvested material receiving device which is secured to the main frame, wherein the harvested material receiving device is configured to receive harvested material from underlying ground, and wherein the harvested material conveying device is configured to convey the harvested material received by the harvested material receiving device. The invention is preferably used in a receiving apparatuses which in addition to the harvested material conveying device also have a harvested material receiving device in order, on the one hand, to receive the harvested material from underlying ground and subsequently to transport the harvested material by means of the harvested material conveying device.

In another preferred embodiment, the attachment is in the form of a cutting mechanism which further has a mowing device which is secured to the main frame and which is configured to separate or cut harvested material from field soil and to transfer the separated or cut harvested material to the harvested material conveying device which is configured to convey the harvested material transversely relative to a harvesting direction.

The agricultural harvesting machine is preferably in the form of a self-driving field chopper.

Preferred further developments of the invention will be appreciated from the dependent claims and the following description. Exemplary embodiments of the invention are, without being limited thereto, explained in greater detail with reference to the drawings, in which:

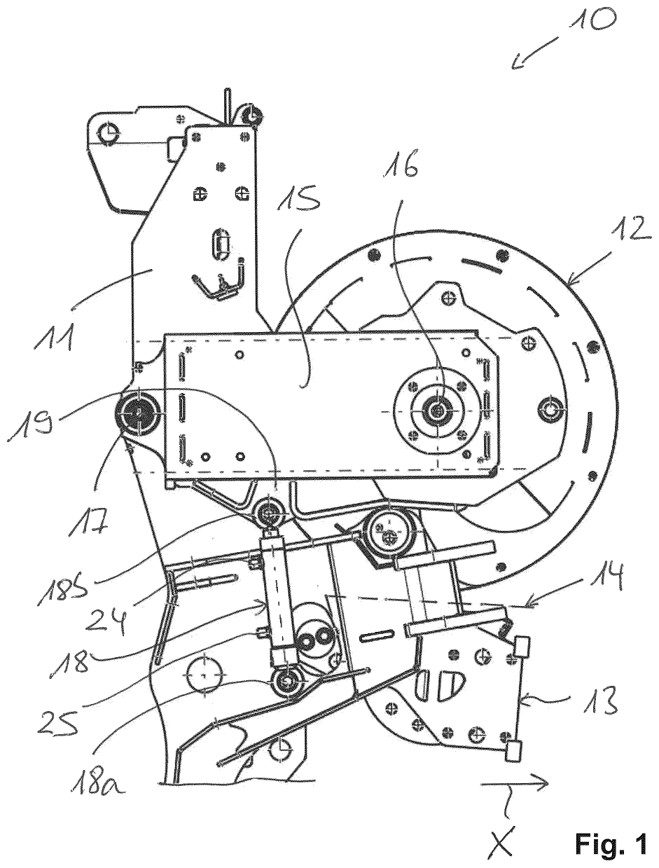

FIG. 1 shows a side view of a detail of an attachment which is in the form of a receiving apparatus for an agricultural harvesting machine in a first state thereof,

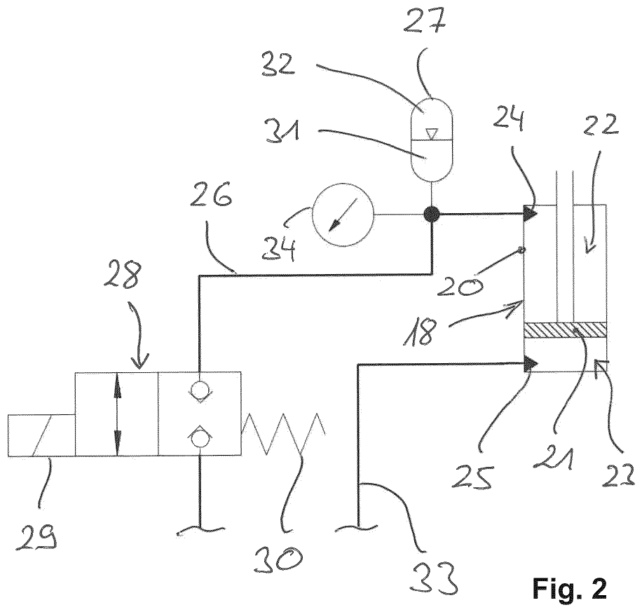

FIG. 2 shows a cut-out of a hydraulic system of the attachment of FIG. 1.

FIG. 1 shows a side view of an attachment 10 which is in the form of a receiving apparatus for harvested material for an agricultural harvesting machine.

The attachment 10 has a main frame 11 which is configured to couple the attachment 10 to an agricultural harvesting machine, in particular to a self-driving field chopper. The attachment 10 has a harvested material receiving device not shown in FIG. 1 and a harvested material conveying device 12 shown in FIG. 1. The harvested material receiving device (not shown in FIG. 1) is mounted below the harvested material conveying device 12 on an assembly flange 13 of the main frame 11. The harvested material receiving device is configured to receive harvested material from underlying ground. The harvested material is in this instance preferably in the form of a so-called swath on the underlying ground which was formed in a previous working step during the mowing of the harvested material or after the mowing.

The harvested material conveying device 12 which is used to convey the harvested material received by the harvested material receiving device which is not shown cooperates with a base metal sheet 14. The base metal sheet 14 is arranged on the harvested material receiving device not shown and forms a conveying base for the harvested material conveying device 12.

In order to transport the harvested material, the harvested material conveying device 12 is pressed or pulled with a defined pretensioning in the direction towards the base metal sheet 14.

The harvested material conveying device 12 is rotatably supported on the carriers 15 and pivotably secured via the carrier 15 to the main frame 11. FIG. 1 shows a rotation axis 16 about which the harvested material conveying device 12 is rotatably supported on the carriers 15. Such a carrier 15 is arranged at each of the two lateral ends of the harvested material conveying device 12.

Furthermore, FIG. 1 shows a pivot axis 17, about which the carriers 15 of the harvested material conveying device 12 can be pivoted relative to the main frame 11, in particular in order to adjust the spacing between the harvested material conveying device 12 and the base metal sheet 14 and thus to adjust a pretensioning between the harvested material conveying device 12 and base metal sheet 14.

As already set out, the base metal sheet 14 is arranged in a transition region between the harvested material receiving device which is not shown in FIG. 1 and the harvested material conveying device 12 shown in FIG. 1. The base metal sheet 14 is in this instance positioned below the harvested material conveying device 12.

The harvested material conveying device 12 which is in particular in the form of a cross-feeding auger conveys the harvested material in cooperation with the base metal sheet 14 to a central region of the attachment 10, where it is transferred to the harvesting machine.

During operation, the attachment 10 is moved by the agricultural harvesting machine in the movement direction X, wherein when viewed in this movement direction X the base metal sheet 14 is arranged behind the harvested material receiving device which is not shown.

In order to now adjust the spacing between the harvested material conveying device 12 and the base metal sheet 14 and consequently also a pretensioning between the harvested material conveying device 12 and the base metal sheet 14 in a defined manner, the attachment 10 has at least one hydraulic cylinder 18 which is secured with a first end 18a directly or indirectly in an articulated manner to the main frame 11 and with an opposing second end 18b in an articulated manner to a carrier 15 or to an auxiliary frame 19 which is in particular securely connected to the carrier 15.

Preferably, at both sides of the harvested material conveying device 12 there is provided in each case such a hydraulic cylinder 28 which, on the one hand, is mounted directly or indirectly on the main frame 11 and, on the other hand, engages in an articulated manner with or is mounted in an articulated manner on one of the carriers 15 or the auxiliary frame 19 at both sides of the harvested material conveying device 12.

The hydraulic cylinder 18 is configured to press or pull the harvested material conveying device 12 with a defined pretensioning in the direction towards the base metal sheet 14. To this end, a pressure chamber of the hydraulic cylinder 18 is filled with hydraulic oil. According to the magnitude of the desired pretensioning, the hydraulic oil pressure of the introduced hydraulic oil is adjusted.

The corresponding pressure chamber of the or each hydraulic cylinder 18 is to this end preferably connected to a hydraulic store 27.

Preferably, the or both hydraulic cylinders 18 is/are in the form of dual-action hydraulic cylinders.

Via the at least one preferred dual-action hydraulic cylinder 18, the spacing between the harvested material conveying device 12 and the base metal sheet 14 can be changed. It is thus possible, on the one hand, for the harvested material conveying device 12 to be pressed or pulled with a defined pretensioning in the direction towards the base metal sheet 14, on the other hand, the harvested material conveying device 12 can be moved away from the base plate 14 and consequently raised or lifted out in order to increase the spacing with respect to the base metal sheet 14.

FIG. 2 shows a cut-out from a hydraulic system of the attachment 10 with a preferably dual-action hydraulic cylinder 18, wherein the dual-action hydraulic cylinder 18 has a cylinder 20 and a piston 21 which can be displaced in the cylinder 20. At both sides of the piston 21 a hydraulic chamber 22, 23 is formed in each case, wherein a hydraulic connection 24, 25 of the hydraulic cylinder 18 cooperates with each of the hydraulic chambers 22, 23.

When a first hydraulic chamber 22 is filled with hydraulic oil and hydraulic oil is discharged from a second hydraulic chamber 23, the harvested material conveying device 12 is pressed or pulled on the base metal sheet 14, wherein a pretensioning of the harvested material conveying device 12 with respect to the base metal sheet 14 is adjusted. The magnitude of the pretensioning is determined by the size of the hydraulic oil pressure. By means of corresponding adjustment of the hydraulic oil pressure, the pretensioning can be changed.

When the second hydraulic chamber 23 is filled with hydraulic oil and hydraulic oil is discharged from the first hydraulic chamber 22, the harvested material conveying device 12 is moved away from the base plate 14.

The first hydraulic chamber 22 is coupled by means of a first hydraulic line 26 to a hydraulic store 27 and a hydraulic oil pump which is not shown in FIG. 2. A switchable valve 28 is incorporated in this first hydraulic line 26, wherein in the blocking position of the valve 28 shown in FIG. 2 the hydraulic pump which is not shown is separated from the first hydraulic chamber 22 of the dual-action hydraulic cylinder 18.

In the blocking position of the valve 28 shown in FIG. 2, however, the hydraulic store 27 is connected to the first hydraulic chamber 22. If the valve 28 of FIG. 2 assumes a passage position, in which the valve 28 can be displaced by means of an actuator 29 counter to the resilient force of a resilient element 30, the first hydraulic chamber 22 of the dual-action hydraulic cylinder 18 is additionally connected to the hydraulic pump which is not shown.

The hydraulic store 27 is, on the one hand, filled with hydraulic oil 31 and, on the other hand, with a gas filling 32. The pressure, produced by a hydraulic pump, of the hydraulic oil 31 in the hydraulic store 27 and in the first hydraulic chamber 22 determines the magnitude of the pretensioning with which the harvested material conveying device 12 is pressed or pulled in the direction towards the base metal sheet 14 by means of the at least one hydraulic cylinder 18. Via the manometer 33 shown in FIG. 2, the hydraulic pressure and thus the pretensioning between the harvested material conveying device 12 and base metal sheet 14 can be detected. Alternatively or additionally, a pressure sensor for detecting the hydraulic oil pressure may be provided.

The hydraulic store 27 also serves to receive hydraulic oil flowing out of the hydraulic chamber 22 when the harvested material conveying device 12, for example, as a result of an increasing quantity of harvested material or as a result of a foreign body has to be redirected outwards.

The second hydraulic chamber 23 is coupled by means of a second hydraulic line 33 to a hydraulic pump in order to supply hydraulic oil to the second hydraulic chamber 23. The pressure in the second hydraulic chamber 23 can thereby be increased in order to raise the harvested material conveying device 12 and move it away from the base metal sheet 14. When lifting out the harvested material conveying device 12, the valve 28 is moved counter to the force of the resilient element 30 into the passage position thereof in order, when lifting out or raising the harvested material conveying device to discharge hydraulic oil from the first hydraulic chamber 22 so that when lifting out or raising the harvested material conveying device 12 the pretensioning is deactivated or is not effective.

With the invention, with little structural space requirement, a defined pretensioning between the harvested material conveying device 12 and the base metal sheet 14 can be provided. The power density can thereby be increased. Furthermore, the harvested material conveying device 12 can advantageously be lifted out or raised. This is carried out in each case via the at least one preferred dual-action hydraulic cylinder 18 which, on the one hand, engages directly or indirectly on the main frame 11 and, on the other hand, on the carriers 15 for the harvested material conveying device 12 or on an auxiliary frame 19 for the same device 12.

With the invention, the pretensioning between the harvested material conveying device 12 and the base metal sheet 14 can be adapted, in particular automatically depending on the harvesting conditions.

Alternatively, in order to pretension the harvested material conveying device 12, single-action hydraulic cylinders which, for example, are in the form of pull cylinders or so-called plunger cylinders could also be provided. According to the dual-action hydraulic cylinder described above, the pressure chamber of a single-action hydraulic cylinder is also connected to the hydraulic store.

### LIST OF REFERENCE NUMERALS

10 Attachment
11 Main frame
12 Harvested material conveying device
13 Assembly flange
14 Base metal sheet
15 Carrier
16 Rotation axis
17 Pivot axis
18 Hydraulic cylinder
18a End
18b End
19 Auxiliary frame
20 Cylinder
21 Piston
22 Hydraulic chamber
23 Hydraulic chamber
24 Hydraulic connection
25 Hydraulic connection
26 Hydraulic line
27 Hydraulic store
28 Valve
29 Actuator
30 Spring
31 Hydraulic oil
32 Gas filling
33 Hydraulic line
34 Manometer/pressure sensor

1. Attachment (10) for an agricultural harvesting machine
having a main frame (11) which is configured to couple the attachment (10) to the agricultural harvesting machine,
having a harvested material conveying device (12) which is secured to the main frame (11) by means of carriers (15) in such a manner that the harvested material conveying device (12) is rotatably supported on the carriers (15) and can be pivoted together with the carriers (15) with respect to the main frame (11), wherein the harvested material conveying device (12) is configured to convey the harvested material in cooperation with a base metal sheet (14),
characterized in that
at least one hydraulic cylinder (18) engages directly or indirectly on the main frame (11) and on at least one carrier (15) or an auxiliary frame (19) which is connected to the carriers (15),
the at least one hydraulic cylinder (18) is configured to press or pull the harvested material conveying device (12) with a defined pretensioning in the direction towards the base metal sheet (14).

2. Attachment (10) according to claim 1, characterized in that
a pressure chamber, which is responsible for the pretensioning, of the or each hydraulic cylinder (18) is connected to a hydraulic store (27).

3. Attachment (10) according to claim 1 or 2, characterized in that
the respective hydraulic cylinder (18) is in the form of a dual-action hydraulic cylinder (18) and has a cylinder (20) and a piston (21) which can be displaced in the cylinder (20), wherein at both sides of the piston (21) a hydraulic chamber (22, 23) is formed,
when a first hydraulic chamber (22) is filled with hydraulic oil with a predetermined hydraulic oil pressure, the harvested material conveying device (12) under a resulting pretensioning between the harvested material conveying device (12) and base metal sheet (14) is pressed or pulled in the direction towards the base metal sheet (14).

4. Attachment (10) according to claim 3, characterized in that,
when a second hydraulic chamber (22) is filled with hydraulic oil, the harvested material conveying device (12) is moved away from the base metal sheet (14).

5. Attachment (10) according to claim 3 or 4, characterized in that
the first hydraulic chamber (22) is coupled by means of a first hydraulic line (26) to a hydraulic store (27) and a hydraulic pump, wherein in the first hydraulic line (26) there is arranged a switchable valve (28) which in a first position connects the hydraulic pump to the first hydraulic chamber (22) and which in a second position separates the hydraulic pump from the first hydraulic chamber (22).

6. Attachment (10) according to claim 5, characterized in that
the hydraulic store (27) is connected to the first hydraulic chamber (22) in both positions of the valve (28).

7. Attachment (10) according to claim 5 or 6, characterized in that
the second hydraulic chamber (23) is coupled to a hydraulic pump by means of a second hydraulic line (33).

8. Attachment (10) according to any one of claims 1 to 7, characterized in that
it is in the form of a receiving apparatus which further has a harvested material receiving device which is directly or indirectly secured to the main frame (11), wherein the harvested material receiving device is configured to receive harvested material from underlying ground, and wherein the harvested material conveying device (12) is configured to convey the harvested material received by the harvested material receiving device.

9. Attachment (10) according to any one of claims 1 to 7, characterized in that the attachment (10) is in the form of a cutting mechanism which further has a mowing device which is secured to the main frame (11) and which is configured to separate or cut harvested material from a field soil and to transfer the separated or cut harvested material to the harvested material conveying device (12) which is configured to convey the harvested material transversely relative to a harvesting direction.

10. Attachment (10) according to any one of the preceding claims, characterized in that at both sides of the harvested material conveying device (12) a dual-action hydraulic cylinder (18) engages in each case directly or indirectly on the main frame (11) and on the respective carrier (15) or on the auxiliary frame (19).

11. Agricultural harvesting machine, in particular self-driving field chopper, having an attachment (1) according to any one of claims 1 to 10.
